(19) United States
(12) Patent Application Publication
(10) Pub. No.: US 2016/0099605 A1
(43) Pub. Date: Apr. 7, 2016

(54) SYSTEMS AND DEVICES FOR WIRELESS POWER CHARGING

(71) Applicant: Nien-Tsu Chen, New Taipei (TW)

(72) Inventor: Nien-Tsu Chen, New Taipei (TW)

(21) Appl. No.: 14/870,030

(22) Filed: Sep. 30, 2015

Related U.S. Application Data
(60) Provisional application No. 62/059,149, filed on Oct. 2, 2014.

(51) Int. Cl. H02J 7/02; H02J 7/00; H02J 5/00

(52) U.S. Cl. CPC H02J 7/025; H02J 5/005; H02J 7/007

(57) ABSTRACT

The present invention discloses a system for wireless power charging. The wireless power charging system may include a transmitting device having a power source, a resonant driving unit and a transmitting coil. The power source may provide an electrical current to the resonant driving unit. The resonant driving unit may create an oscillating amount of energy to be fed to the transmitting coil at a resonant frequency. The wireless power charging system may also include a receiving device having a receiving coil magnetically coupled to the transmitting coil to transfer the energy from the transmitting device to the receiving device at the resonant frequency, wherein the receiving device has a battery to be charged by the energy.

### CROSS-REFERENCE TO RELATED APPLICATIONS

This application is related to and claims priority to U.S. provisional patent application, U.S. Provisional Application No. 62/059,149 filed on Oct. 2, 2014, by the applicant Nien Tsu Chen, entitled “Methods and Devices for Wireless Power Charging.”

### FIELD OF THE INVENTION

The present invention relates to systems and devices for wireless power charging; more particularly, the present invention relates to wireless power charging systems that utilize resonant electric circuits to wirelessly charge portable devices or home appliances.

### BACKGROUND OF THE INVENTION

Current wireless power charging technique utilizes an electromagnetic induction to transfer energy between two devices. Such technique requires a device to be placed on or in very close proximity to a charging station or a charging pad. This configuration limits the number of devices that may be charged at the same time. Another drawback of using the conventional technique is that it takes a long time to charge due to its low power standard.

Therefore, what is needed is a wireless power charging system that utilizes resonant electric circuits to wirelessly charge portable devices or home appliances. More particularly, what is needed is a wireless power charging system that utilizes resonant electric circuits to wirelessly charge portable devices or home appliances without a charging station or a charging pad such that the portable devices or home appliances may be placed at a distance but still be charged quickly.

### SUMMARY OF THE INVENTION

In light of the drawbacks of the above prior arts, one object of the present invention is to provide a wireless power charging system.

In accordance with the present invention, the wireless power charging system may include a transmitting device having a power source, a resonant driving unit and a transmitting coil. The power source may provide an electrical current to the resonant driving unit. The resonant driving unit may create an oscillating amount of energy to be fed to the transmitting coil at a resonant frequency. The wireless power charging system may also include a receiving device having a receiving coil magnetically coupled to the transmitting coil to transfer the energy from the transmitting device to the receiving device at the resonant frequency, wherein the receiving device has a battery to be charged by the energy.

Another object of the present invention is to provide a wireless power transmitting device adapted to use with an electronic device installed with a wireless power receiving device. The wireless power receiving device may include a receiving coil.

In accordance with the present invention, the wireless power transmitting device may include a power source providing an electrical current, a resonant driving unit creating an oscillating amount of energy from the electrical current, and a transmitting coil being fed with the energy at a resonant frequency, wherein the transmitting coil is magnetically coupled to the receiving coil to transfer the energy to the wireless power receiving device at the resonant frequency so as to charge the electronic device.

Yet another object of the present invention is to provide a wireless power receiving device adapted to use with a wireless power transmitting device. The wireless power transmitting device may include a power source, a resonant driving unit and a transmitting coil. The power source may provide an electrical current to the resonant driving unit to create an oscillating amount of energy to feed the transmitting coil at a resonant frequency.

In accordance with the present invention, the wireless power receiving device may include a receiving coil magnetically coupled to the transmitting coil to transfer the energy from the wireless power transmitting device to the wireless receiving device at the resonant frequency.

Certain embodiments of the invention have other aspects in addition to or in place of those mentioned above. The aspects will become apparent to those skilled in the art from reading of the following detailed description when taken with reference to the accompanying drawings.

### BRIEF DESCRIPTION OF DRAWINGS

FIG. 1 is a schematic view of a wireless power charging system in accordance with one embodiment of the present invention.

### DETAILED DESCRIPTION OF THE INVENTION

The following embodiments are described in sufficient detail to enable those skilled in the art to make and use the invention. It is to be understood that other embodiments would be evident based on the present disclosure, and that changes may be made without departing from the scope of the present invention.

The present invention provides a wireless power charging system. In particular, the present invention provides a wireless power charging system that utilizes resonant electric circuits to wirelessly charge portable devices or home appliances without a charging station or a charging pad such that the portable devices or home appliances may be placed at a distance but still be charged quickly.

In one embodiment of the present invention, the wireless power charging system may be implemented with a Solid State Tesla Coil (SSTC) such that high voltages may be produced without the disadvantages of a spark gap, such as the loud noise and high temperatures. As a result, the wireless power charging system of the present invention may wirelessly charge a portable device or a large home appliance located at a distance without the need for a charging station or a charging pad.

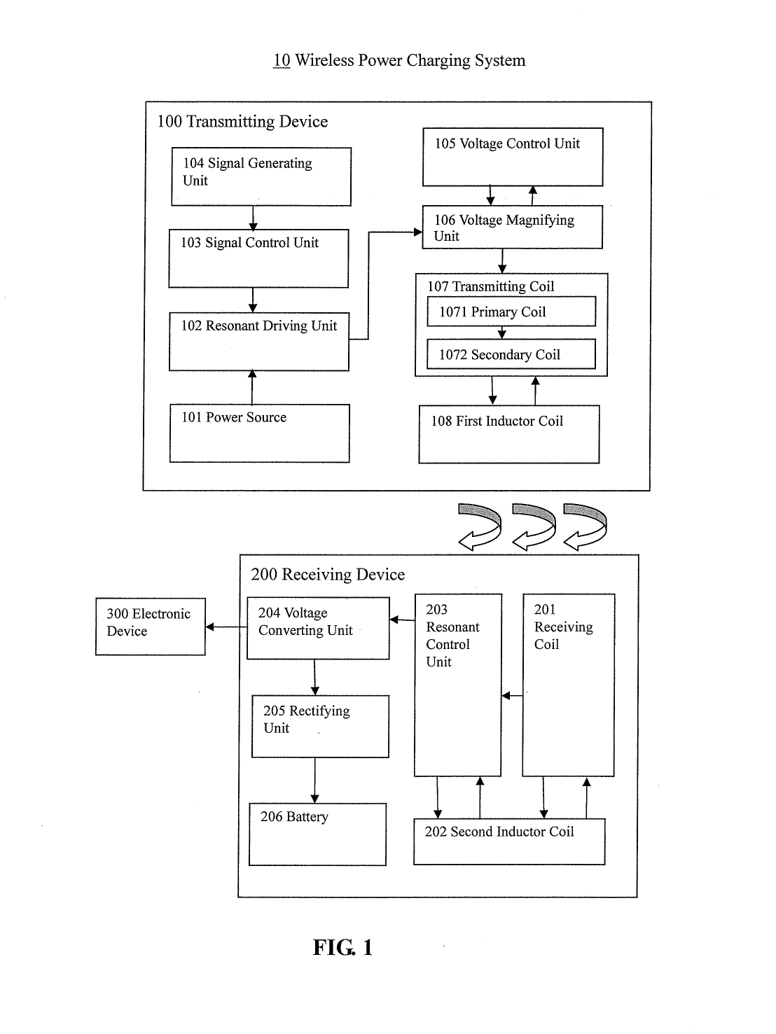

Refer to FIG. 1, which illustrates a schematic view of a wireless power charging system in accordance with one embodiment of the present invention. As shown in FIG. 1, in one embodiment of the present invention, the wireless power charging system 10 may include a transmitting device 100. The transmitting device 100 of the present invention may include a power source 101 to provide an electrical current. In one embodiment of the present invention, the power source 101 may be a battery; however, those ordinarily skilled in the art should know that any other types of power source that may generate an electrical current also fall within the scope of the present invention.

In one embodiment of the present invention, the transmitting device 100 may further include a resonant driving unit 102. The resonant driving unit 102 of the present invention may oscillate the electrical current generated from the power source 101 and create a high voltage pulse signal. In one example, the resonant driving unit 102 of the present invention may create a high frequency sine wave signal.

In one embodiment of the present invention, the high voltage pulse signal created by the resonant driving unit 102 may be sent to a voltage magnifying unit 106 to further magnify the pulse signal before an oscillating amount of energy created by the resonant driving unit 102 is fed to the transmitting coil 107. The transmitting device 100 of the present invention may also include a voltage control unit 105, as shown in FIG. 1, to stabilize the high voltage created within the transmitting device 100.

In one embodiment of the present invention, the transmitting coil 107 may store the electrical energy received from the voltage magnifying unit 106 at a resonant frequency driven by the resonant driving unit 102. In one embodiment of the present invention, the transmitting coil 107 may be implemented by a number of turns of a wire so that a circular magnetic field is generated when the electrical current passes therethrough. As a result, the electrical energy may be stored in the magnetic field of the transmitting coil 107. Additionally, the transmitting coil 107 of the present invention may be connected with a capacitor such that the electrical energy may be stored in its electric field. In accordance with the present invention, the electrical energy may oscillate back and forth between the transmitting coil 107 and the capacitor at the resonant frequency.

As shown in FIG. 1, the transmitting coil 107 of the present invention may include a primary coil 1071 and a secondary coil 1072. The two coils placed in close proximity increase the magnetic field generated, and thus the high voltage electrical energy may be stored in both the primary coil 1071 and the secondary coil 1072.

In one embodiment of the present invention, the transmitting device 100 may further include a first inductor coil 108. In accordance with the present invention, the first inductor coil 108 may store the high voltage electrical energy in its magnetic field at the same resonant frequency.

In accordance with the present invention, the transmitting device 100 may also include a signal generating unit 104 to generate an electric signal to the resonant driving unit 102. The transmitting device 100 of the present invention may further include a signal control unit 103 to control the electric signal sent to the resonant driving unit 102.

In accordance with the present invention, the wireless power charging system 10 may include a receiving device 200. The receiving device 200 may be installed on a portable device or a home appliance so as to charge the portable device or a home appliance wirelessly without the need of a charging station or a charging pad.

As shown in FIG. 1, the receiving device 200 of the present invention may include a receiving coil 201 magnetically coupled to the transmitting coil 107 of the transmitting device 100 to allow energy transfer from the transmitting device 100 to the receiving device 200. In one embodiment of the present invention, the receiving coil 201 may be implemented by a number of turns of a wire so that the energy transferred from the transmitting device 100 may be stored in the circular magnetic field of the receiving coil 201. Similarly, the receiving coil 201 of the present invention may be connected with a capacitor. In one embodiment of the present invention, the capacitor of the receiving device 200 may be grounded.

In one embodiment of the present invention, the receiving device 200 may further include a second inductor coil 202. In accordance with the present invention, the second inductor coil 202 may store the high voltage electrical energy in its magnetic field at the same resonant frequency.

In one embodiment of the present invention, the receiving device 200 may optionally include a resonant control unit 203 to control the resonance occurred within the receiving device 200. The resonant control unit 203 of the present invention may send the electrical energy to the voltage converting unit 204 so as to convert the electrical energy to an alternating current.

As shown in FIG. 1, in one embodiment of the present invention, the alternating current may then be sent to a rectifying unit 205 to rectify the alternating current to a direct current before charging the battery 206 within the receiving device 200. Alternatively, the voltage converting unit 204 may send the alternating current directly to an electronic device 300, such as a mobile phone device or a home appliance, so as to charge the electronic device 300 directly.

While the invention has been described in conjunction with exemplary preferred embodiments, it is to be understood that many alternatives, modifications, and variations will be apparent to those skilled in the art in light of the foregoing description. Accordingly, it is intended to embrace all such alternatives, modifications, and variations that fall within the scope of the included claims. The scope of the claims, therefore, should be accorded the broadest interpretation so as to encompass all such modifications and similar arrangements. All matters set forth herein or shown in the accompanying drawings are to be interpreted in an illustrative and non-limiting sense.

What is claimed is:

1. A wireless power charging system, said system comprising:
a transmitting device having a power source, a resonant driving unit and a transmitting coil, said power source providing an electrical current to said resonant driving unit, said resonant driving unit creating an oscillating amount of energy to be fed to said transmitting coil at a resonant frequency,
a receiving device having a receiving coil magnetically coupled to said transmitting coil to transfer said energy from said transmitting device to said receiving device at said resonant frequency,
wherein said receiving device has a battery to be charged by said energy.

2. The system of claim 1, wherein said transmitting device further comprises a voltage magnifying unit to magnify said energy.

3. The system of claim 1, wherein said transmitting device further comprises a voltage control unit to stabilize said energy.

4. The system of claim 1, wherein said transmitting coil includes a primary coil and a secondary coil to magnify said energy.

5. The system of claim 1, wherein said transmitting device further comprises a first inductor coil to create a magnetic field to store said energy.

6. The system of claim 1, wherein said transmitting device further comprises a signal generating unit to generate an electric signal to said resonant driving unit.

7. The system of claim 6, wherein said transmitting device further comprises a signal control unit to control said electric signal sent to said resonant driving unit.

8. The system of claim 1, wherein said receiving device further comprises a voltage converting unit to convert said energy to an alternating current.

9. The system of claim 1, wherein said receiving device further comprises a second inductor coil to create a magnetic field to store said energy.

10. The system of claim 1, wherein said receiving device further comprises a resonant control unit to control said energy.

11. The system of claim 8, wherein said receiving device further comprises a rectifying unit to rectify said alternating current to a direct current to charge said battery.

12. The system of claim 1, wherein said receiving device is installed on an electronic device.

13. A wireless power transmitting device adapted to use with an electronic device installed with a wireless power receiving device, said wireless power receiving device comprising a receiving coil, said wireless power transmitting device comprising:
a power source providing an electrical current,
a resonant driving unit creating an oscillating amount of energy from said electrical current,
a transmitting coil being fed with said energy at a resonant frequency,
wherein said transmitting coil is magnetically coupled to said receiving coil to transfer said energy to said wireless power receiving device at said resonant frequency so as to charge said electronic device.

14. The device of claim 13, wherein said wireless power transmitting device further comprises a voltage magnifying unit to magnify said energy.

15. The device of claim 13, wherein said transmitting device further comprises a voltage control unit to stabilize said energy.

16. The device of claim 13, wherein said transmitting coil includes a primary coil and a secondary coil to magnify said energy.

17. The device of claim 13, wherein said wireless power transmitting device further comprises an inductor coil to create a magnetic field to store said energy.

18. The device of claim 13, wherein said wireless power transmitting device further comprises a signal generating unit to generate an electrical signal to said resonant driving unit.

19. The device of claim 18, wherein said wireless power transmitting device further comprises a signal control unit to control said electrical signal.

20. A wireless power receiving device adapted to use with a wireless power transmitting device, said wireless power transmitting device comprising a power source, a resonant driving unit and a transmitting coil, said power source providing an electrical current to said resonant driving unit to create an oscillating amount of energy to feed said transmitting coil at a resonant frequency, said wireless power receiving device comprising:
a receiving coil magnetically coupled to said transmitting coil to transfer said energy from said wireless power transmitting device to said wireless receiving device at said resonant frequency.

21. The device of claim 20, wherein said wireless power receiving device further comprises a battery to be charged by said energy.

22. The device of claim 20, wherein said wireless power receiving device further comprises a voltage converting unit to convert said energy to an alternating current.

23. The device of claim 20, wherein said wireless power receiving device further comprises an inductor coil to create a magnetic field to store said energy.

24. The device of claim 20, wherein said wireless power receiving device further comprises a resonant control unit to control said energy.

25. The device of claim 22, wherein said wireless power receiving device further comprises a rectifying unit to rectify said alternating current to a direct current to charge said second battery.

26. The device of claim 20, wherein said wireless power receiving device is installed on an electronic device so as to charge said electronic device.
